(19) United States
(12) Patent Application Publication
(10) Pub. No.: US 2026/0236809 A1
(43) Pub. Date: Aug. 13, 2026

(54) ELECTRONIC DEVICE AND METHOD WITH MODEL QUANTIZATION

(71) Applicant: SAMSUNG ELECTRONICS CO., LTD., Suwon-si (KR)

(72) Inventors: Meng HUANG, Xi’an (CN); Miao ZHANG, Xi’an (CN); Jong Hoon YOON, Suwon-si (KR); Feng ZHU, Xi’an (CN); Yunhao ZHANG, Xi’an (CN); Zhenxin YANG, Xi’an (CN); Sung-Jae CHO, Suwon-si (KR); Chang Yong SON, Suwon-si (KR)

(73) Assignee: SAMSUNG ELECTRONICS CO., LTD., Suwon-si (KR)

(21) Appl. No.: 19/434,402

(22) Filed: Dec. 29, 2025

(30) Foreign Application Priority Data
Feb. 8, 2025 (CN) 202510146933.X
Aug. 22, 2025 (KR) 10-2025-0117604

(51) Int. Cl. G06N 7/01

(52) U.S. Cl. CPC G06N 7/01

(57) ABSTRACT

An electronic device includes one or more processors comprising processing circuitry, and memory comprising one or more storage media storing instructions that, when executed individually or collectively by the one or more processors, cause the electronic device to determine quantization sensitivity estimates (QSEs) of one or more convolutional layers included in a model to be quantized, according to a corresponding QSE, determine probabilities of selecting predetermined candidate quantization bit widths in each of the one or more convolutional layers, based on the determined probabilities for the one or more convolutional layers, determine candidate quantization models for the model by quantizing the one or more convolutional layers, and based on a predetermined condition for the candidate quantization models, quantize the model by selecting a quantization model from the candidate quantization models.

### CROSS-REFERENCE TO RELATED APPLICATIONS

This application claims the benefit under 35 USC § 119 (a) of Chinese Patent Application No. 202510146933.X filed on Feb. 8, 2025 in the China National Intellectual Property Administration, and Korean Patent Application No. 10-2025-0117604 filed on Aug. 22, 2025 in the Korean Intellectual Property Office, the entire disclosures of which are incorporated herein by reference for all purposes.

### BACKGROUND

### 1. Field

The following description relates to an electronic device and method with model quantization.

### 2. Description of Related Art

A neural network may be used to resolve a complex task in various fields (e.g., computer vision or natural language processing). Model quantization may be performed to reduce model complexity and storage capacity usage to improve the inference speed of the model and more effectively use a neural network for an edge device with limited computing performance and storage capacity. In addition, the model may be efficiently deployed in a deep learning field through model quantization. For example, model quantization may reduce the model size and accelerate runtime by representing a model weight and activation in the runtime using a fixed-point.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes one or more processors comprising processing circuitry, and memory comprising one or more storage media storing instructions that, when executed individually or collectively by the one or more processors, cause the electronic device to determine quantization sensitivity estimates (QSEs) of one or more convolutional layers included in a model to be quantized, according to a corresponding QSE, determine probabilities of selecting predetermined candidate quantization bit widths in each of the one or more convolutional layers, based on the determined probabilities for the one or more convolutional layers, determine candidate quantization models for the model by quantizing the one or more convolutional layers, and based on a predetermined condition for the candidate quantization models, quantize the model by selecting a quantization model from the candidate quantization models.

For the determining of the QSEs, the execution of the instructions may cause the electronic device to determine convolutional layer information about the one or more convolutional layers by parsing the model, and determine the QSE based on the convolutional layer information and a pre-trained parameter for the model, and the convolutional layer information may include any one or any combination of any two or more of a number of input channels, a number of output channels, and a sampling matrix of the convolutional layers.

For the determining of the QSE, the execution of the instructions may cause the electronic device to, for each of the one or more convolutional layers, determine intermediate QSEs of the corresponding convolutional layer through a plurality of sampling matrices, and determine a mean of the intermediate QSEs to be the QSE of the convolutional layer.

For the determining of the QSE, the execution of the instructions may cause the electronic device to, for each of the one or more convolutional layers, determine a Hessian matrix of the corresponding convolutional layer based on a pre-trained parameter for the model, and based on the Hessian matrix, determine the QSE of the convolutional layer.

For the determining of the probabilities of selecting each of the predetermined candidate quantization bit widths, the execution of the instructions may cause the electronic device to, for each of the one or more convolutional layers, determine a quantization sensitivity distribution of the corresponding convolutional layer based on the QSE of the convolutional layer, determine a quantization sensitivity envelope point of the convolutional layer based on the quantization sensitivity distribution, and determine the probabilities of selecting each of the predetermined candidate quantization bit widths in the convolutional layer based on the quantization sensitivity envelope point.

For the determining of the candidate quantization models, the execution of the instructions may cause the electronic device to determine first candidate quantization models from the candidate quantization models according to whether a memory occupancy rate of the candidate quantization models is less than or equal to a predetermined quantization memory occupancy limit, and select the quantization model from the first candidate quantization models, and the candidate quantization models may have different quantization bit widths.

For the determining of the candidate quantization models, the execution of the instructions may cause the electronic device to, for each of the one or more convolutional layers, quantize the one or more convolutional layers in descending order of a sum of the probabilities.

For the determining of the candidate quantization models, the execution of the instructions may cause the electronic device to, for each of the candidate quantization models, determine whether the memory occupancy rate is less than or equal to the predetermined quantization memory occupancy limit, determine candidate quantization models in which the memory occupancy rate is less than or equal to the predetermined quantization memory occupancy limit to be the first candidate quantization models, determine duplication among the first candidate quantization models, determine first candidate quantization models that are not duplicated from the first candidate quantization models to be second candidate quantization models, and select the quantization model from the second candidate quantization models.

For the quantizing of the model, the execution of the instructions may cause the electronic device to determine a precision of the candidate quantization models, and based on the precision, select the quantization model from the candidate quantization models.

For the selecting of the quantization model, the execution of the instructions may cause the electronic device to select, from among the candidate quantization models, a candidate quantization model having either one or both of a precision exceeding a predetermined threshold and a highest precision.

The one or more convolutional layers may not include a convolutional layer positioned first in the model.

In one or more general aspects, a processor-implemented method includes determining quantization sensitivity estimates (QSEs) of one or more convolutional layers included in a model to be quantized, according to a corresponding QSE among the determined QSEs, determining probabilities of selecting predetermined candidate quantization bit widths in each of the one or more convolutional layers, based on the determined probabilities for the one or more convolutional layers, determining candidate quantization models for the model by quantizing the one or more convolutional layers, and based on a predetermined condition for the candidate quantization models, quantizing the model by selecting a quantization model that quantizes the model from the candidate quantization models.

The determining of the QSEs may include determining convolutional layer information about the one or more convolutional layers by parsing the model, and determining a QSE based on the convolutional layer information and a pre-trained parameter for the model, and the convolutional layer information may include any one or any combination of any two or more of a number of input channels, a number of output channels, and a sampling matrix of the convolutional layers.

The determining of the QSE may include, for each of the one or more convolutional layers, determining intermediate QSEs of the corresponding convolutional layer through a plurality of sampling matrices, and determining a mean of the intermediate QSEs to be the QSE of the convolutional layer.

Thee determining of the QSE may include, for each of the one or more convolutional layers, determining a Hessian matrix of the corresponding convolutional layer based on a pre-trained parameter for the model, and based on the Hessian matrix, determining the QSE of the convolutional layer.

The determining of the probabilities of selecting each of the predetermined candidate quantization bit widths may include, for each of the one or more convolutional layers, determining a quantization sensitivity distribution of the corresponding convolutional layer based on the QSE of the convolutional layer, determining a quantization sensitivity envelope point of the convolutional layer based on the quantization sensitivity distribution, and determining the probabilities of selecting each of the predetermined candidate quantization bit widths in the convolutional layer based on the quantization sensitivity envelope point.

The determining of the candidate quantization models may include determining first candidate quantization models from the candidate quantization models according to whether a memory occupancy rate of the candidate quantization models is less than or equal to a predetermined quantization memory occupancy limit, and selecting the quantization model from the first candidate quantization models, and the candidate quantization models may have different quantization bit widths.

The determining of the candidate quantization models may include, for each of the one or more convolutional layers, quantizing the one or more convolutional layers in descending order of a sum of the probabilities.

The determining of the candidate quantization models may include, for each of the candidate quantization models, determining whether the memory occupancy rate is less than or equal to the predetermined quantization memory occupancy limit, determining candidate quantization models in which the memory occupancy rate is less than or equal to the predetermined quantization memory occupancy limit to be the first candidate quantization models, determining duplication among the first candidate quantization models, determining first candidate quantization models that are not duplicated from the first candidate quantization models to be second candidate quantization models, and selecting the quantization model from the first candidate quantization models.

The quantizing of the model may include determining a precision of the candidate quantization models, and based on the precision, selecting the quantization model from the candidate quantization models.

Other features and aspects will be apparent from the following detailed description, the drawings, and the claims.

### BRIEF DESCRIPTION OF THE DRAWINGS

FIG. 1 is a diagram illustrating an operating method of an electronic device according to one or more embodiments.

FIG. 2 is a diagram illustrating an operation of determining a quantization sensitivity estimate according to one or more embodiments.

FIG. 3 is a diagram illustrating an operation of determining probabilities of selecting each of a plurality of predetermined candidate quantization bit widths according to one or more embodiments.

FIG. 4 is a diagram illustrating operations of determining candidate quantization models and selecting a quantization model according to one or more embodiments.

FIG. 5 is a diagram illustrating components included in an electronic device according to one or more embodiments.

FIG. 6 is a diagram illustrating an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and specifically in the context on an understanding of this disclosure. It will be further understood that terms, such as those defined in commonly-used dictionaries, should be interpreted as having a meaning that is consistent with their meaning in the context of the relevant art and specifically in the context of this disclosure, and will not be interpreted in an idealized or overly formal sense unless expressly so defined herein.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, embodiments will be described in detail with reference to the accompanying drawings. When describing the embodiments with reference to the accompanying drawings, like reference numerals refer to like elements and a repeated description related thereto will be omitted.

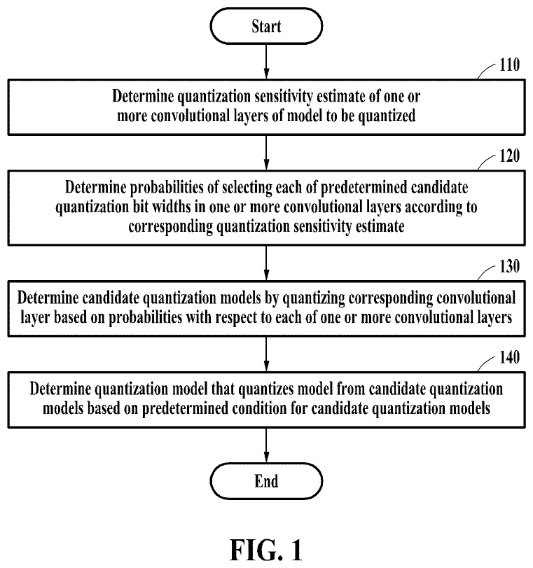

FIG. 1 is a diagram illustrating an operating method of an electronic device according to one or more embodiments.

Referring to FIG. 1, an electronic device may provide a mixed precision quantization method based on quantization sensitivity estimates of one or more convolutional layers included in a model through operations 110 to 140. In addition, the electronic device may designate a memory occupancy range and may search various mixed precision quantization models using an evaluation index for memory occupancy of the model. A model to be quantized may be an artificial intelligence (AI) model including one or more convolutional layers. For example, the model to be quantized may be a deep learning model and/or a convolutional neural network (CNN) model, but the embodiment is not limited thereto.

The electronic device may include a preprocessing module (PM), a search module (SM), and a quantization model (QM), but may further include other modules depending on the embodiment. The electronic device may parse the model to be quantized through the PM and may determine quantization sensitivity estimates of the convolutional layers. The electronic device may determine probabilities of quantization bit widths according to the quantization sensitivity estimate value through the SM, and may select a sufficient number of candidate quantization models by expanding the number of candidate quantization models. The electronic device may determine the accuracy of candidate quantization models through the QM and may select a quantization model from the candidate quantization models, thereby quantizing the model. Through this, by considering a data distribution among convolutional layers included in the model, the electronic device of one or more embodiments may reduce the time for selecting the quantization model and may improve the precision of the quantization model.

In the following embodiments, operations (e.g., operations 110 to 140 of FIG. 1) may be performed sequentially but not necessarily. For example, depending on the embodiment, one or more of the operations may be performed in different orders, two or more of the operations may be performed in parallel or simultaneously, one or more of the operations may be omitted, and/or other operations may be additionally performed without departing from the spirit and scope of the described embodiments. Operations 110 to 140 may be performed by at least one component (e.g., a processor, etc.) of the electronic device.

In operation 110, the electronic device may determine quantization sensitivity estimates of one or more convolutional layers included in a model to be quantized.

According to one or more embodiments, the one or more convolutional layers for determining the quantization sensitivity estimates may not include a convolutional layer that is positioned first in the model to be quantized. For example, the electronic device may not determine the quantization sensitivity estimate of the first convolutional layer. For example, the model to be quantized may include the first convolutional layer, one or more fully connected layers, and one or more convolutional layers used for determining the quantization sensitivity estimates.

According to one or more embodiments, the electronic device may determine convolutional layer information about the one or more convolutional layers by parsing the model and may determine the quantization sensitivity estimates based on a pre-trained parameter (e.g., a weight) with respect to the model and the convolutional layer information. In this case, the convolutional layer information may include at least one of the number of input channels of the convolutional layers, the number of output channels, and a sampling matrix. For example, the electronic device may determine the number of input channels for the one or more convolutional layers, the number of output channels, and the sampling matrix by parsing the model and may determine the quantization sensitivity estimates based on the determined number of input channels, the determined number of output channels, the determined sampling matrix, and the pre-trained parameter. Through this, the electronic device of one or more embodiments may improve the speed of determining the quantization sensitivity estimate of the convolutional layer.

According to one or more embodiments, for each of the one or more convolutional layers, the electronic device may determine intermediate quantization sensitivity estimates of the corresponding convolutional layer through a plurality of sampling matrices and may determine a mean of the intermediate quantization sensitivity estimates to be the quantization sensitivity estimate of the convolutional layer.

According to one or more embodiments, for each of the one or more convolutional layers, the electronic device may determine a Hessian matrix of the convolutional layer based on the pre-trained parameter for the model and may determine the quantization sensitivity estimate of the convolutional layer based on the Hessian matrix. In one or more embodiments, for each of the one or more convolutional layers, the electronic device may determine the Hessian matrix of the pre-trained parameter of the convolutional layer and may determine the quantization sensitivity estimate of each convolutional layer based on the Hessian matrix, the number of input channels, the number of output channels, and the sampling matrix.

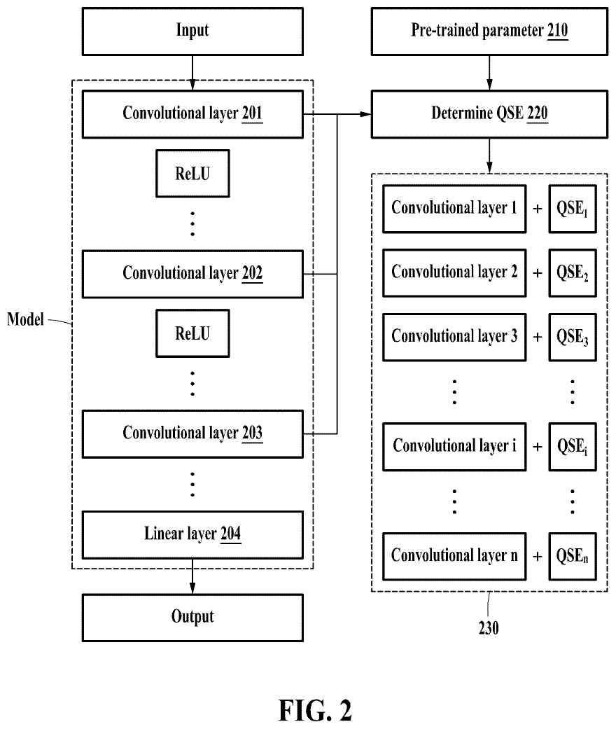

An example of operation 110 of determining the quantization sensitivity estimates is further described with reference to FIG. 2.

In operation 120, the electronic device may determine probabilities of selecting each of predetermined candidate quantization bit widths in each of the one or more convolutional layers according to the corresponding quantization sensitivity estimate. Quantization bit width probability information may indicate probabilities of selecting each of the predetermined candidate quantization bit widths for the one or more convolutional layers. Herein, for ease of description, the bit width may also be referred to as a bit count.

According to one or more embodiments, for each of the one or more convolutional layers, the electronic device may determine a quantization sensitivity distribution based on the quantization sensitivity estimate of the corresponding convolutional layer, may determine a quantization sensitivity envelope point of the convolutional layer based on the quantization sensitivity distribution, and may determine the probabilities of selecting each of the predetermined candidate quantization bit widths in the convolutional layer based on the quantization sensitivity envelope point. Herein, for ease of description, the quantization sensitivity distribution may also be referred to as a quantization sensitivity data distribution.

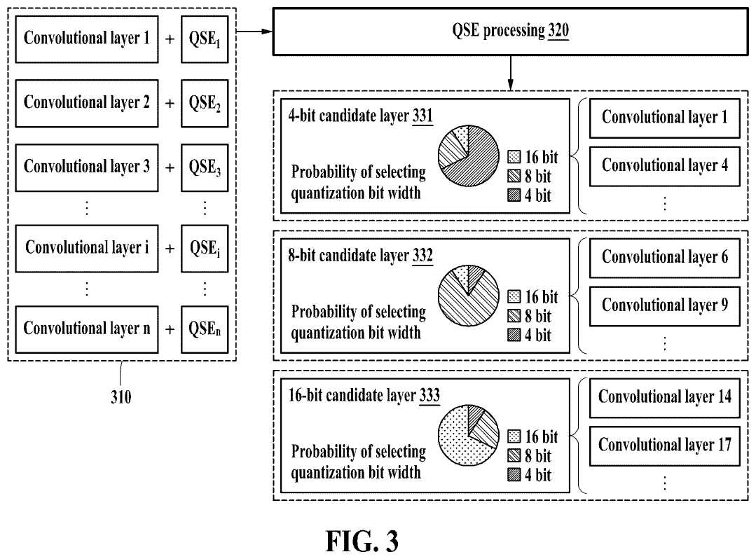

An example of operation 120 of determining the probabilities of selecting each of the predetermined candidate quantization bit widths in the convolutional layers is further described with reference to FIG. 3.

In operation 130, the electronic device may determine candidate quantization models for the model by quantizing the one or more convolutional layers based on the probabilities determined for the one or more convolutional layers.

According to one or more embodiments, the electronic device may determine first candidate quantization models from the candidate quantization models and may select a quantization model from the first candidate quantization models according to whether memory occupancy rates of the candidate quantization models are less than or equal to a predetermined quantization memory occupancy limit. In this case, the candidate quantization models may have different candidate quantization bit widths. In one or more embodiments, the electronic device may determine a first candidate quantization model of the model to be quantized by quantizing each of the one or more convolutional layers based on the quantization bit width probability information of the one or more convolutional layers. The electronic device may determine a predetermined number of quantization candidate models from the determined first quantization candidate model based on the predetermined quantization memory occupancy limit. In this case, in any two of first candidate quantization models among the predetermined number of first candidate quantization models, the one or more convolutional layers may have different candidate quantization bit widths.

According to one or more embodiments, for each of the one or more convolutional layers, the electronic device may quantize the one or more convolutional layers in descending order of the sum of probabilities. In one or more embodiments, for each of the one or more convolutional layers, the electronic device may sequentially determine the order by the candidate quantization bit width in descending order of quantization bit width probability in the quantization bit width probability information of the corresponding convolutional layer, thereby determining the quantization candidate model by quantizing the corresponding convolutional layer. For example, the electronic device may determine the quantization candidate model by sorting the sum of quantization bit width probabilities of the one or more convolutional layers (e.g., the sum of quantization bit width probabilities of three convolutional layers) in descending order.

According to one or more embodiments, for each of the candidate quantization models, the electronic device may determine whether the memory occupancy rate is less than or equal to the predetermined quantization memory occupancy limit, may determine the candidate quantization models having the memory occupancy rates less than or equal to the predetermined quantization memory occupancy limit to be the first candidate quantization models, may determine duplication among the first candidate quantization models, may determine the first candidate quantization models that are not duplicated from the first candidate quantization models to be the second candidate quantization models, and may select a quantization model from the second candidate quantization models. In one or more embodiments, the electronic device may determine whether the candidate quantization models for the model satisfy a predetermined quantization memory occupancy limit condition (e.g., whether the memory occupancy rate is less than or equal to the predetermined quantization memory occupancy limit). Based on the determination that the candidate quantization models for the model satisfy the predetermined quantization memory occupancy limit, the electronic device may determine the candidate quantization models satisfying the predetermined quantization memory occupancy limit condition to be the first candidate quantization models until a first predetermined number is reached. The electronic device may perform duplication determination on the first predetermined number of first candidate quantization models and may select the first candidate quantization models that are not duplicated from the first predetermined number of first candidate quantization models to be a second predetermined number of second candidate quantization models. In this case, in two of the second candidate quantization models among the second predetermined number of second candidate quantization models, one or more convolutional layers may have different quantization bit widths. The electronic device may select the second candidate quantization models satisfying the predetermined quantization memory occupancy limit condition from the second predetermined number of second candidate quantization models to be a predetermined number of candidate quantization models. In addition, the electronic device may select a quantization model that quantizes the model from the predetermined number of candidate quantization models. Through this, the electronic device of one or more embodiments may reduce the memory occupancy of the candidate quantization model and may maintain the verification accuracy of the candidate quantization model.

In operation 140, the electronic device may quantize the model by selecting the quantization model from the candidate quantization models based on a predetermined condition for the candidate quantization models. In this case, the predetermined condition may indicate, for example, a condition related to the precision or memory occupancy of the candidate quantization model, but the one or more embodiments are not limited thereto. For example, depending on the one or more embodiments, the electronic device may select the quantization model from the candidate quantization models based on another reference value for evaluating the performance of the quantization model.

According to one or more embodiments, the electronic device may determine precision of the candidate quantization models and may select the quantization model from the candidate quantization models based on the precision. In one or more embodiments, the electronic device may select the candidate quantization model in which the precision of the model exceeds a predetermined threshold from the candidate quantization models. Alternatively, from the candidate quantization models, the electronic device may select the candidate quantization model having the highest precision to be the quantization model.

According to one or more embodiments, the electronic device may determine a memory occupancy rate of the candidate quantization models and may select the quantization model from the candidate quantization models based on the memory occupancy rate. In one or more embodiments, the electronic device may select the candidate quantization model in which the memory occupancy rate of the model is less than or equal to a predetermined memory occupancy threshold from the candidate quantization models. Alternatively, from the candidate quantization models, the electronic device may select the candidate quantization model having the lowest memory occupancy rate in a memory occupied state to be the quantization model.

According to one or more embodiments, the electronic device may determine a precision and a memory occupancy rate of the candidate quantization models and may select the quantization model from the candidate quantization models based on the precision and memory occupancy rate. In one or more embodiments, the electronic device may select the candidate quantization model in which the precision of the model exceeds the predetermined threshold and the memory occupancy rate is less than or equal to the memory occupancy threshold to be the quantization model. Through this, the electronic device of one or more embodiments may select a quantization model with great quantization effect and improve the quantization efficiency.

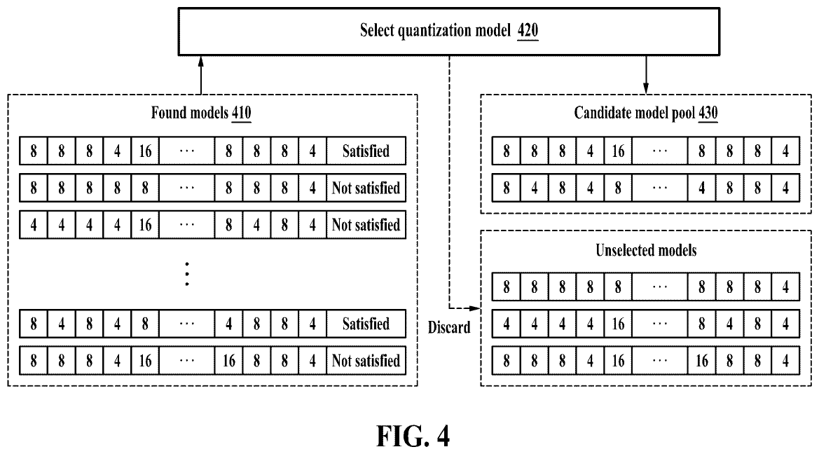

An example of operation 130 of determining the candidate quantization models and operation 140 of selecting the quantization model from the candidate quantization models are further described with reference to FIG. 4.

FIG. 2 is a diagram illustrating an operation of determining a quantization sensitivity estimate according to one or more embodiments.

Referring to FIG. 2, in operation 220, an electronic device may determine quantization sensitivity estimates (QSEs) 230 of one or more convolutional layers 201, 202, and 203 included in a model using a pre-trained parameter 210. In the example of FIG. 2, the number of convolutional layers 201, 202, and 203 included in the model is illustrated as three for description, but the one or more embodiments are not limited thereto, and the number of convolutional layers may be one or more. In addition, the sizes of one or more convolutional layers 201, 202, and 203 may be the same or different from each other. For example, the one or more convolutional layers 201, 202, and 203 may be the 7×7 convolutional layer 201, the 3×3 convolutional layer 202, and the 1×1 convolutional layer 203, and accordingly, the sizes thereof may be different from each other. Depending on the one or more embodiments, the model may further include layers (e.g., a rectified linear unit (ReLU) layer and a linear layer 204) different from the convolutional layers.

In the example of FIG. 2, the electronic device may determine the one or more convolutional layers 201, 202, and 203 included in the model by analyzing the model. In operation 220, the electronic device may determine quantization sensitivity estimates of the one or more convolutional layers 201, 202, and 203 based on the pre-trained parameter 210 and the one or more convolutional layers 201, 202, and 203. In one or more embodiments, the electronic device may determine the quantization sensitivity estimate of the corresponding layer using the pre-trained parameter 210 corresponding to the one or more convolutional layers 201, 202, and 203.

For example, when the electronic device has a neural network having m parameters, the electronic device may determine a gradient vector g_{θ} for a weight L of the neural network as Equation 1 below, for example.

$${g}_{θ} = \frac{\partial L}{\partial θ} ∈ {ℝ}^{m} \qquad Equation 1$$

In Equation 1, [symbol] ^{m} may denote an m-dimensional vector, and

$$\frac{\partial L}{\partial θ}$$

may denote a first derivative of the weight L for a variable θ.

The electronic device may determine a second derivative of a weight, which is a derivative of a gradient vector as Equation 2 below, for example.

$${H}_{θ} = \frac{{\partial }^{2} L}{\partial {θ}^{2}} = \frac{\partial {g}_{θ}}{\partial θ} ∈ {ℝ}^{m \times m} \qquad Equation 2$$

In Equation 2, H_{θ} may denote a Hessian matrix, [symbol] ^{m×m} may denote an m×m matrix (a matrix of m rows and m columns),

$$\frac{{\partial }^{2} L}{\partial {θ}^{2}}$$

may denote a second derivative of the weight L for the variable θ, and

$$\frac{\partial {g}_{θ}}{\partial θ}$$

may denote a first derivative of a gradient vector g_{θ} for the variable θ.

The electronic device may determine the quantization sensitivity estimate of the convolutional layer based on the Hessian matrix of the convolutional layer. In one or more embodiments, the electronic device may determine the quantization sensitivity estimate of the convolutional layer using the Hessian matrix of weights for channels of the convolutional layer. For example, when a Hessian matrix of an i-th convolutional layer is Hᵢ, the electronic device may determine the corresponding quantization sensitivity estimate as Equation 3 below, for example.

$$Q S {E}_{i} = {\sum }_{{C}_{i} = 1}^{In \_ C} {\sum }_{{C}_{o} = 1}^{Out \_ C} \frac{{x}^{T} \cdot ( {H}_{{i}_{\{ {C}_{i} , {C}_{o} \}}} \cdot {𝒩}_{{i}_{\{ {C}_{i} , {C}_{o} \}}} ) \cdot x}{In\_C \cdot Out\_C} \qquad Equation 3$$

In Equation 3, In_C and Out_C may respectively denote the number of input channels and the number of output channels of the corresponding convolutional layer, [symbol] may denote a sampling matrix following a Gaussian distribution (e.g., a Gaussian distribution in which a mean is 0 and a distribution is 1), x may denote a vector of which all elements are 1, Hᵢ may denote a Hessian matrix for a weight of the i-th convolutional layer, Cᵢ may denote an input channel, and Cₒ may denote an output channel.

According to one or more embodiments, to reduce an error in quantization sensitivity estimation that may occur due to randomness of a sampling matrix, for each of the one or more convolutional layers, the electronic device of one or more embodiments may determine intermediate quantization sensitivity estimates of the corresponding convolutional layer through a plurality of sampling matrices and may determine a mean of the intermediate quantization sensitivity estimates to be the quantization sensitivity estimate of the convolutional layer. For example, the electronic device may determine intermediate quantization sensitivity estimates of the i-th convolutional layer through a plurality of rounds and may obtain a mean Q̅S̅E̅ᵢ of the determined intermediate quantization sensitivity estimates. The electronic device may normalize the determined mean Q̅S̅E̅ᵢ for each convolutional layer, thereby determining a quantization sensitivity estimate QSE of the corresponding convolutional layer. For example, the electronic device may determine the QSE based on the mean of intermediate quantization sensitivity estimates as Equation 4 below, for example.

$$Q S {E}_{Normalized} = \{ {{⋃}^{Total Conv}}_{i = 1} \frac{2}{π} \cdot arctan \vert {\overline{Q S E}}_{i} \vert \} \qquad Equation 4$$

In Equation 4, QSE_{Normalized} may denote a normalized QSE, Q̅S̅E̅ᵢ may denote a mean of intermediate quantization sensitivity estimates of each convolutional layer, and

$${⋃}_{i = 1}^{Total Conv} \frac{2}{π} \cdot arctan \vert {\overline{Q S E}}_{i} \vert$$

may denote normalization processing for Q̅S̅L̅ᵢ of each convolutional layer.

FIG. 3 is a diagram illustrating an operation of determining probabilities of selecting each of a plurality of predetermined candidate quantization bit widths according to one or more embodiments.

Referring to FIG. 3, an electronic device may determine the probabilities of selecting each of predetermined candidate quantization bit widths in one or more convolutional layers, according to quantization sensitivity estimates (QSEs) 310 of the one or more convolutional layers. The electronic device may determine quantization bit width-wise candidate layers 331, 332, and 333 each corresponding to a respective convolutional layer, according to the probabilities of selecting each of the candidate quantization bit widths in the one or more convolutional layers.

For example, with respect to a network (e.g., MobileNet-V2 network) including a total of 53 convolutional layers, the electronic device may determine a quantization sensitivity estimate of 52 convolutional layers included in the network. In this case, the first convolutional layer of the network may be excluded from determining the quantization sensitivity estimate. When deep convolutional layers of the network include a large number of channels, the quantization sensitivity estimate may gradually decrease (e.g., may gradually decrease for each subsequent layer of the convolutional layers). As the number of channels of the convolutional layers increases, the quantization sensitivity estimate may have a gradually decreasing scale of a quantization sensitivity distribution.

For example, with respect to 53 convolutional layers included in a ResNet-50 network, the electronic device may determine a quantization sensitivity estimate. The quantization sensitivity estimate of the corresponding network may rapidly decrease from the 28th layer to a low level (e.g., from the 28th layer to subsequent layers), and may have a little variation in a normalized graph. When using a threshold method, quantization sensitivity estimate information from the 28th layer to the 53rd layer of the corresponding network may not be significant. In addition, in the modular convolution structure design of the ResNet-50 network, a recurrent structure may be shown as a group. In the corresponding network, convolutional layers in the same group may have similar quantization sensitivity estimate distributions, and the difference in quantization sensitivity estimate distributions of convolutional layers among different groups may be significant.

In operation 320, the electronic device may process the quantization sensitivity estimates 310 of the one or more convolutional layers, thereby determining the probabilities of selecting each of the predetermined candidate quantization bit widths in the one or more convolutional layers. According to one or more embodiments, the electronic device may process the quantization sensitivity estimates 310 of the convolutional layer by determining a quantization sensitivity envelope point of the convolutional layer to decrease the influence of a data scale difference between convolutional layer groups included in the network and not to ignore the similarity of the quantization sensitivity estimate distribution in the convolution group. For example, the electronic device may determine an envelope point of the quantization sensitivity distribution using an upper envelope and a lower envelope for the quantization sensitivity distribution and may apply a mixed-precision quantization method to the determined envelope point.

According to one or more embodiments, the electronic device may analyze the quantization sensitivity distribution of the model using an envelope and may adjust a quantization bit width of the corresponding convolutional layer for the envelope point using the mixed-precision quantization method. The envelope point may have representativeness compared to surrounding adjacent points and may reflect the quantization sensitivity distribution information in the corresponding group. In addition, when the envelope point has a minimum or maximum quantization sensitivity estimate compared to adjacent points, the envelope point may have relatively small quantization sensitivity compared to the actual quantization sensitivity, and accordingly, mixed quantization points may be evenly distributed and the electronic device of one or more embodiments may prevent a quantization point from being concentrated in a deep convolutional layer.

When some of the one or more convolutional layers included in the model use a low quantization bit width (e.g., 2 bits), the verification accuracy of the quantized model may be reduced. In addition, when there are too many convolutional layers using the low quantization bit width, convergence speed of the quantization model may increase. Thus, according to one or more embodiments, the electronic device of one or more embodiments may determine the probability of selecting a relatively low candidate quantization bit width (e.g., 2 bits) to be 0 and may select quantization bit widths of the convolutional layers from the remaining candidate quantization bit widths (e.g., 4 bits, 8 bits, or 16 bits) other than the candidate quantization bit width, thereby increasing the verification accuracy of the quantized model and/or decreasing the convergence speed of the quantization model. For example, the electronic device may determine a quantization weight of the relatively low candidate quantization bit width to be a first value (e.g., “0”).

In the example of FIG. 3, in operation 320, the electronic device may determine a quantization sensitivity distribution for the model based on the quantization sensitivity estimates 310 of the convolutional layers included in the model. The electronic device may determine convolutional layers (e.g., convolution layer 14 and convolution layer 17 of FIG. 3) corresponding to points passing an upper envelope in the quantization sensitivity distribution, to be a 16-bit candidate layer 333. The 16-bit candidate layer 333 may have a probability of selecting the highest quantization bit width (e.g., the quantization weight), and accordingly, the probability of selecting the 4-bit quantization bit width and 8-bit quantization bit width may be reduced. When the 16-bit candidate layer 333 has a higher quantization sensitivity estimate than the other candidate layers, the corresponding convolutional layers may be predicted to have a high probability of having great quantization sensitivity. Since quantization of a relatively low quantization bit width may decrease the verification accuracy of the corresponding convolutional layers, the verification accuracy of the model may be maintained using a relatively high quantization bit width for convolutional layers predicted to have a high probability of having great quantization sensitivity. In addition, the electronic device may determine convolutional layers (e.g., convolution layer 1 and convolution layer 4 of FIG. 3) corresponding to points passing a lower envelope in the quantization sensitivity distribution, to be a 4-bit candidate layer 331. The 4-bit candidate layer 331 may be quantized by the 4-bit quantization bit width with a relatively high probability, and the remaining 8-bit quantization bit width probability and 16-bit quantization bit width probability may be reduced. When the 4-bit candidate layer 331 has a lower quantization sensitivity estimate than the other candidate layers, the 4-bit candidate layer 331 may be used for low-precision quantization that is relatively guaranteed. The electronic device may determine convolutional layers (e.g., convolutional layer 6 and convolutional layer 9 of FIG. 3) corresponding to the remaining points other than the points corresponding to the 16-bit candidate layer 333 and the 4-bit candidate layer 331, to be an 8-bit candidate layer 332. The 8-bit candidate layer 332 may also be used for the following quantization model search process.

In the example of FIG. 3, the candidate layers 331, 332, and 333 are examples for description, and the one or more embodiments are not limited thereto. For example, the quantization bit width of each of the candidate layers 331, 332, and 333 may be determined differently.

FIG. 4 is a diagram illustrating operations of determining candidate quantization models and selecting a quantization model according to one or more embodiments.

Referring to FIG. 4, an electronic device may determine candidate quantization models for a model to be quantized by quantizing one or more convolutional layers based on probabilities of selecting each of predetermined candidate quantization bit widths in the one or more convolutional layers. In addition, the electronic device may select a quantization model that quantizes a model from the determined candidate quantization models based on a predetermined condition for the candidate quantization models.

According to one or more embodiments, the electronic device may search for the candidate quantization model based on probabilities of selecting each of different candidate quantization bit widths in each of the convolutional layers. In one or more embodiments, to distinguish the structural difference of found models 410, in operation 420, the electronic device may determine models in which memory occupancy rates are less than or equal to a quantization memory occupancy limit from the found models 410 using the determined quantization memory occupancy limit as Equation 5 below, for example.

$$B - MAC = {\sum }_{i = 1}^{Total Conv} {BitNum}_{{Activation}_{i}} \cdot {BitNum}_{{Weight}_{i}} \cdot MAC \qquad Equation 5$$

In Equation 5, B-MAC may denote a quantization memory occupancy limit, MAC may denote a memory occupancy rate, i=1 may denote a first convolutional layer,

$${\sum }_{i = 1}^{Total Conv}$$

may denote the sum of BitNum_{Activation}_{ᵢ}· BitNum_{Weight}_{ᵢ}· MAC from the first convolutional layer to the last convolutional layer, BitNum_{Activation}_{ᵢ} may denote a quantization bit width of an activation value or output value of convolutional layer i, and BitNum_{Weight}_{ᵢ} may denote a quantization bit width of a weight of convolutional layer i.

In operation 420, the electronic device may determine whether the memory occupancy rate is less than or equal to the quantization memory occupancy limit for each of the found models 410 and may discard models in which the memory occupancy rates exceed the quantization memory occupancy limit. The electronic device may repeatedly determine whether the memory occupancy rate of the found models 410 is less than or equal to the quantization memory occupancy limit until selecting a first predetermined number of models. The models selected according to the quantization memory occupancy limit may be included in a candidate model pool 430. The electronic device may prevent the same model from being repeatedly selected by determining duplication among the models included in the candidate model pool 430. In response to determining duplication, the electronic device may determine a second predetermined number (e.g., 3) of models from the models included in the candidate model pool 430 based on the B-MAC and may determine precisions of the models.

According to one or more embodiments, for the models included in the candidate model pool 430, the electronic device may sequentially quantize the models using a quantization interrupt learning (QIL) method. The electronic device may replace convolutional layers (e.g., nn.Conv2d) of the models with quantized convolutional layers (e.g., QConv2d) and may quantize input information (e.g., nBitAct) and weight information (e.g., nBitWei) of each of the convolutional layers by the same quantization bit width (e.g., nBitAct=nBitWei). In one or more embodiments, the electronic device may perform quantization via a model quantizer. To prevent accuracy loss of the model due to quantization, the electronic device may maintain full precision without quantization with respect to the first convolutional layer (1st Conv2d Layer) and all fully connected layers (Linear Layer). The electronic device may perform precision verification using a quantized model trainer. In one or more embodiments, the electronic device of one or more embodiments may reduce the time required for quantization model search using guidance of a quantization sensitivity estimate of the convolutional layer, may perform quantization sensitivity processing of self-adaptive high generalization performance, and may thereby improve the effectiveness and efficiency of model quantization.

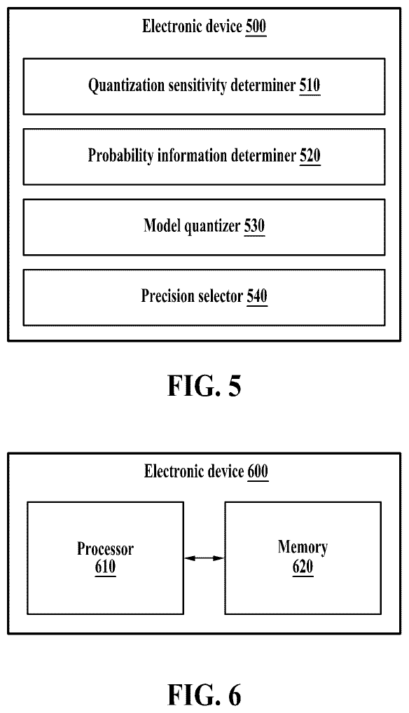

FIG. 5 is a diagram illustrating components included in an electronic device according to one or more embodiments.

Referring to FIG. 5, an electronic device 500 may include a quantization sensitivity determiner 510, a probability information determiner 520, a model quantizer 530, and a precision selector 540. The modules 510, 520, 530, and 540 illustrated in FIG. 5 are examples for description, and depending on the one or more embodiments, some components may be omitted or additional components may be further included in the electronic device 500. In addition, the components 510, 520, 530, and 540 illustrated in FIG. 5 are illustrated as hardware or devices provided in the electronic device 500 separately, but the one or more embodiments are not limited thereto. For example, operations of the components 510, 520, 530, and 540 illustrated in FIG. 5 may be implemented by hardware included in the electronic device 500.

The quantization sensitivity determiner 510 may determine a quantization sensitivity estimate of one or more convolutional layers included in a model to be quantized. The quantization sensitivity determiner 510 may determine convolutional layer information about the one or more convolutional layers by parsing the model and may determine the quantization sensitivity estimate based on the convolutional layer information and a pre-trained parameter for the model. For each of the one or more convolutional layers, the quantization sensitivity determiner 510 determine intermediate quantization sensitivity estimates of the corresponding convolutional layer through a plurality of sampling matrices and may determine a mean of the intermediate quantization sensitivity estimates to be the quantization sensitivity estimate of the convolutional layer. For each of the one or more convolutional layers, the quantization sensitivity determiner 510 may determine a Hessian matrix of the convolutional layer based on the pre-trained parameter for the model and may determine the quantization sensitivity estimate of the convolutional layer based on the Hessian matrix.

The probability information determiner 520 may determine the probabilities of selecting each of predetermined candidate quantization bit widths in each of the one or more convolutional layers according to the corresponding quantization sensitivity estimate. For each of the one or more convolutional layers, the probability information determiner 520 may determine a quantization sensitivity distribution based on the quantization sensitivity estimate of the corresponding convolutional layer, may determine a quantization sensitivity envelope point of the convolutional layer based on the quantization sensitivity distribution, and may determine the probabilities of selecting each of the predetermined candidate quantization bit widths in the convolutional layer based on the quantization sensitivity envelope point.

The model quantizer 530 may determine first candidate quantization models from the candidate quantization models and may select a quantization model from the first candidate quantization models according to whether memory occupancy rates of the candidate quantization models are less than or equal to a predetermined quantization memory occupancy limit. For each of the one or more convolutional layers, the model quantizer 530 may quantize the one or more convolutional layers in descending order of the sum of probabilities. For each of the candidate quantization models, the model quantizer 530 may determine whether the memory occupancy rate is less than or equal to the predetermined quantization memory occupancy limit, may determine the candidate quantization models having the memory occupancy rates less than or equal to the predetermined quantization memory occupancy limit to be the first candidate quantization models, may determine duplication among the first candidate quantization models, may determine the first candidate quantization models that are not duplicated from the first candidate quantization models to be the second candidate quantization models, and may select a quantization model from the second candidate quantization models.

The precision selector 540 may quantize the model by selecting the quantization model from the candidate quantization models based on a predetermined condition for the candidate quantization models. The precision selector 540 may determine precision of the candidate quantization models and may select the quantization model from the candidate quantization models based on the precision.

FIG. 6 is a diagram illustrating an electronic device according to one or more embodiments.

Referring to FIG. 6, an electronic device 600 may include a processor 610. The processor 610 may be or include one or more processors. In addition, the electronic device 600 may further include a memory 620. The memory 620 may be or include one or more memories.

The memory 620 may store instructions (or programs) executable by the processor 610. For example, the instructions include instructions for performing the operation of the processor 610 and/or an operation of each component of the processor 610. For example, the memory 620 may be or include a non-transitory computer-readable storage medium storing instructions that, when executed by the processor 610, configure the processor 610 to perform any one, any combination, or all of the operations and/or methods described herein with reference to FIGS. 1-6.

The processor 610 may be a device for executing instructions or programs or controlling the electronic device 600, and may include, for example, various processors, such as a central processing unit (CPU) and/or a graphics processing unit (GPU). The processor 610 may determine a quantization sensitivity estimate of one or more convolutional layers included in a model to be quantized. The processor 610 may determine the probabilities of selecting each of predetermined candidate quantization bit widths in each of the one or more convolutional layers according to the corresponding quantization sensitivity estimate. The processor 610 may determine candidate quantization models for the model by quantizing the one or more convolutional layers based on the probabilities determined for the one or more convolutional layers. The processor 610 may quantize the model by selecting the quantization model from the candidate quantization models based on a predetermined condition for the candidate quantization models.

The processor 610 may determine convolutional layer information about the one or more convolutional layers by parsing the model and may determine the quantization sensitivity estimate based on the convolutional layer information and a pre-trained parameter for the model. The convolutional layer information may include at least one of the number of input channels of the convolutional layers, the number of output channels, and a sampling matrix. For each of the one or more convolutional layers, the processor 610 may determine intermediate quantization sensitivity estimates of the corresponding convolutional layer through a plurality of sampling matrices and may determine a mean of the intermediate quantization sensitivity estimates to be the quantization sensitivity estimate of the convolutional layer. For each of the one or more convolutional layers, the processor 610 may determine a Hessian matrix of the convolutional layer based on the pre-trained parameter for the model and may determine the quantization sensitivity estimate of the convolutional layer based on the Hessian matrix. For each of the one or more convolutional layers, the processor 610 may determine a quantization sensitivity distribution based on the quantization sensitivity estimate of the corresponding convolutional layer, may determine a quantization sensitivity envelope point of the convolutional layer based on the quantization sensitivity distribution, and may determine the probabilities of selecting each of the predetermined candidate quantization bit widths in the convolutional layer based on the quantization sensitivity envelope point. The processor 610 may determine first candidate quantization models from the candidate quantization models and may select a quantization model from the first candidate quantization models according to whether memory occupancy rates of the candidate quantization models are less than or equal to a predetermined quantization memory occupancy limit. The candidate quantization models may have different candidate quantization bit widths. For each of the one or more convolutional layers, the processor 610 may quantize the one or more convolutional layers in descending order of the sum of probabilities. For each of the candidate quantization models, the processor 610 may determine whether the memory occupancy rate is less than or equal to the predetermined quantization memory occupancy limit, may determine the candidate quantization models having the memory occupancy rates less than or equal to the predetermined quantization memory occupancy limit to be the first candidate quantization models, may determine duplication among the first candidate quantization models, may determine the first candidate quantization models that are not duplicated from the first candidate quantization models to be the second candidate quantization models, and may select a quantization model from the second candidate quantization models. The processor 610 may determine precision of the candidate quantization models and may select the quantization model from the candidate quantization models based on the precision.

In addition, the electronic device 600 may process the operations described above.

The electronic devices, quantization sensitivity determiners, probability information determiners, model quantizers, precision selectors, processors, memories, electronic device 500, quantization sensitivity determiner 510, probability information determiner 520, model quantizer 530, precision selector 540, electronic device 600, processor 610, and memory 620 described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-6 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors comprising processing circuitry; and
memory comprising one or more storage media storing instructions that, when executed individually or collectively by the one or more processors, cause the electronic device to:
determine quantization sensitivity estimates (QSEs) of one or more convolutional layers included in a model to be quantized;
according to a corresponding QSE, determine probabilities of selecting predetermined candidate quantization bit widths in each of the one or more convolutional layers;
based on the determined probabilities for the one or more convolutional layers, determine candidate quantization models for the model by quantizing the one or more convolutional layers; and
based on a predetermined condition for the candidate quantization models, quantize the model by selecting a quantization model from the candidate quantization models.

2. The electronic device of claim 1, wherein
for the determining of the QSEs, the execution of the instructions causes the electronic device to:
determine convolutional layer information about the one or more convolutional layers by parsing the model; and
determine the QSE based on the convolutional layer information and a pre-trained parameter for the model, and
the convolutional layer information includes any one or any combination of any two or more of a number of input channels, a number of output channels, and a sampling matrix of the convolutional layers.

3. The electronic device of claim 1, wherein, for the determining of the QSE, the execution of the instructions causes the electronic device to:
for each of the one or more convolutional layers, determine intermediate QSEs of the corresponding convolutional layer through a plurality of sampling matrices; and
determine a mean of the intermediate QSEs to be the QSE of the convolutional layer.

4. The electronic device of claim 1, wherein, for the determining of the QSE, the execution of the instructions causes the electronic device to:
for each of the one or more convolutional layers, determine a Hessian matrix of the corresponding convolutional layer based on a pre-trained parameter for the model; and
based on the Hessian matrix, determine the QSE of the convolutional layer.

5. The electronic device of claim 1, wherein, for the determining of the probabilities of selecting each of the predetermined candidate quantization bit widths, the execution of the instructions causes the electronic device to:
for each of the one or more convolutional layers, determine a quantization sensitivity distribution of the corresponding convolutional layer based on the QSE of the convolutional layer,
determine a quantization sensitivity envelope point of the convolutional layer based on the quantization sensitivity distribution; and
determine the probabilities of selecting each of the predetermined candidate quantization bit widths in the convolutional layer based on the quantization sensitivity envelope point.

6. The electronic device of claim 1, wherein
for the determining of the candidate quantization models, the execution of the instructions causes the electronic device to:
determine first candidate quantization models from the candidate quantization models according to whether a memory occupancy rate of the candidate quantization models is less than or equal to a predetermined quantization memory occupancy limit; and
select the quantization model from the first candidate quantization models, and the candidate quantization models have different quantization bit widths.

7. The electronic device of claim 6, wherein, for the determining of the candidate quantization models, the execution of the instructions causes the electronic device to, for each of the one or more convolutional layers, quantize the one or more convolutional layers in descending order of a sum of the probabilities.

8. The electronic device of claim 6, wherein, for the determining of the candidate quantization models, the execution of the instructions causes the electronic device to:
for each of the candidate quantization models, determine whether the memory occupancy rate is less than or equal to the predetermined quantization memory occupancy limit;
determine candidate quantization models in which the memory occupancy rate is less than or equal to the predetermined quantization memory occupancy limit to be the first candidate quantization models;
determine duplication among the first candidate quantization models;
determine first candidate quantization models that are not duplicated from the first candidate quantization models to be second candidate quantization models; and
select the quantization model from the second candidate quantization models.

9. The electronic device of claim 1, wherein, for the quantizing of the model, the execution of the instructions causes the electronic device to:
determine a precision of the candidate quantization models; and
based on the precision, select the quantization model from the candidate quantization models.

10. The electronic device of claim 9, wherein, for the selecting of the quantization model, the execution of the instructions causes the electronic device to select, from among the candidate quantization models, a candidate quantization model having either one or both of a precision exceeding a predetermined threshold and a highest precision.

11. The electronic device of claim 1, wherein the one or more convolutional layers do not include a convolutional layer positioned first in the model.

12. A processor-implemented method comprising:
determining quantization sensitivity estimates (QSEs) of one or more convolutional layers included in a model to be quantized;
according to a corresponding QSE among the determined QSEs, determining probabilities of selecting predetermined candidate quantization bit widths in each of the one or more convolutional layers;
based on the determined probabilities for the one or more convolutional layers, determining candidate quantization models for the model by quantizing the one or more convolutional layers; and
based on a predetermined condition for the candidate quantization models, quantizing the model by selecting a quantization model that quantizes the model from the candidate quantization models.

13. The method of claim 12, wherein
the determining of the QSEs comprises:
determining convolutional layer information about the one or more convolutional layers by parsing the model; and
determining a QSE based on the convolutional layer information and a pre-trained parameter for the model, and
the convolutional layer information includes any one or any combination of any two or more of a number of input channels, a number of output channels, and a sampling matrix of the convolutional layers.

14. The method of claim 12, wherein the determining of the QSE comprises:
for each of the one or more convolutional layers, determining intermediate QSEs of the corresponding convolutional layer through a plurality of sampling matrices; and
determining a mean of the intermediate QSEs to be the QSE of the convolutional layer.

15. The method of claim 12, wherein the determining of the QSE comprises:
for each of the one or more convolutional layers, determining a Hessian matrix of the corresponding convolutional layer based on a pre-trained parameter for the model; and
based on the Hessian matrix, determining the QSE of the convolutional layer.

16. The method of claim 12, wherein the determining of the probabilities of selecting each of the predetermined candidate quantization bit widths comprises:
for each of the one or more convolutional layers, determining a quantization sensitivity distribution of the corresponding convolutional layer based on the QSE of the convolutional layer;
determining a quantization sensitivity envelope point of the convolutional layer based on the quantization sensitivity distribution; and
determining the probabilities of selecting each of the predetermined candidate quantization bit widths in the convolutional layer based on the quantization sensitivity envelope point.

17. The method of claim 12, wherein
the determining of the candidate quantization models comprises:
determining first candidate quantization models from the candidate quantization models according to whether a memory occupancy rate of the candidate quantization models is less than or equal to a predetermined quantization memory occupancy limit; and
selecting the quantization model from the first candidate quantization models, and the candidate quantization models have different quantization bit widths.

18. The method of claim 17, wherein the determining of the candidate quantization models comprises, for each of the one or more convolutional layers, quantizing the one or more convolutional layers in descending order of a sum of the probabilities.

19. The method of claim 17, wherein the determining of the candidate quantization models comprises:
for each of the candidate quantization models, determining whether the memory occupancy rate is less than or equal to the predetermined quantization memory occupancy limit;
determining candidate quantization models in which the memory occupancy rate is less than or equal to the predetermined quantization memory occupancy limit to be the first candidate quantization models;
determining duplication among the first candidate quantization models;
determining first candidate quantization models that are not duplicated from the first candidate quantization models to be second candidate quantization models; and
selecting the quantization model from the first candidate quantization models.

20. The method of claim 12, wherein the quantizing of the model comprises:
determining a precision of the candidate quantization models; and
based on the precision, selecting the quantization model from the candidate quantization models.
